(19) United States
(12) Patent Application Publication
(10) Pub. No.: US 2010/0030819 A1
(43) Pub. Date: Feb. 4, 2010

(54) Method, system and apparatus to seamlessly manage and access files across multiple devices

(75) Inventors: Krishnaswamy Srinivasan, Bangalore (IN); Magesh Margabandu, Bangalore (IN); Sanjeev Madhavankutty, Bangalore (IN)

Correspondence Address: OLIFF & BERRIDGE, PLC, P.O. BOX 320850, ALEXANDRIA, VA, 22320-4850, US

(73) Assignee: ALLGO EMBEDDED SYSTEMS PRIVATE LIMITED, KARNATAKA (IN)

(21) Appl. No.: 12/311,688

(22) PCT Filed: Oct. 18, 2006
(86) PCT No.: PCT/IN2006/000410

§ 371 Date: Apr. 9, 2009

(30) Foreign Application Priority Data
Oct. 10, 2006 (IN) 1876/CHE/2006

(51) Int. Cl. G06F 17/30

(52) U.S. Cl. 707/201; 707/E17.01; 707/E17.005

(57) ABSTRACT

A method, system and apparatus to seamlessly manage and access files across multiple devices in a network, comprising steps of maintaining a local database in each of the devices, synchronizing the local databases of the devices using transaction logs and sync controller, managing and accessing file(s) among the devices using the database.

### BACKGROUND OF INVENTION

1. Field of Invention

The present invention addresses a method, system and apparatus to seamlessly manage and access files across multiple devices in a network. This document describes the higher level software architecture of the proposed AudiGo synchronization mechanism. It describes various scenarios in the AudiGo File Synching and explains how they will be handled with this architecture.

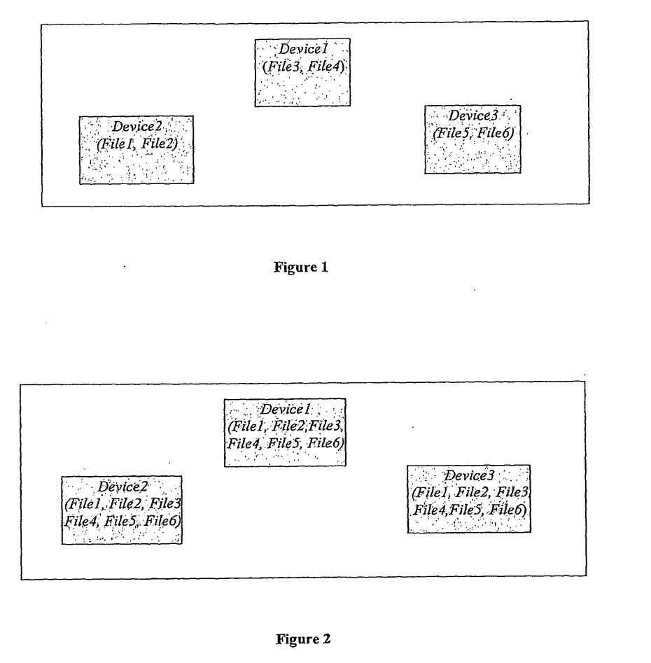

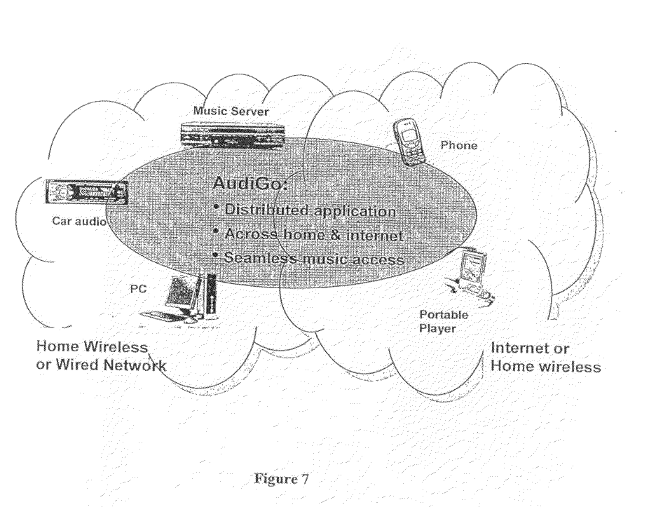

The idea of the AudiGo system is to allow a group of audio devices to interact with each other and share files among themselves in an automated way as shown in FIG. 7. This helps the user to access all the files from any of the devices, irrespective of their actual physical location. Consider the following scenario of three devices each having some files. (See FIG. 1). AudiGo allows the user of any device say device1 to seamlessly see and access all the files file1, file2, file3, file4, file5 and file6. (see FIG. 2) The user does not need to know where the actual file is present. It is the responsibility of the AudiGo system to find out where the file actually exists, get the file from its location and give it to the user. So with AudiGo, from user perspective, all devices would look like the way shown in FIG. 2. When a user accesses a file that is not present in the local storage of his or her device, the device may either download the file from another device and store it in its local storage for future use, or it may just access the file without downloading.

2. Prior Art

US patent application number 2006101064 is the closest citation to our instant technology found during our search. However, the prior art differs from the present invention in that the prior art is for syncing image/video files and not for accessing files even if the files are not in the user's device. Further instant invention has a lot of advantages and is distinct compared to the prior art document. The prior art technology works on the basis of keeping a copy of the shared files in the server which means that the server should be capable of doing so with large storage space in it. Thus it is necessary to have a server with a large amount of storage space capable of storing a copy of all files from all the devices connected to it. This in addition results in duplication of data to avail file sharing. Further, if the server goes down there is no way for one of the Clients in the network to act as a server. The way in which our database automatically builds itself (updates) whenever there is change in the file system is not disclosed in the cited document. The prior art further does not disclose a method to support an mp3 player or any other external storage device which does not have a capability to communicate with other devices but still have files which could be shared. The prior art also relies on a content server heavily for syncing unlike the method disclosed in the instant invention.

### OBJECTS OF PRESENT INVENTION

One of the main objects of the present invention is to develop a method to seamlessly manage and access files across multiple devices in a network.

Yet another object of the present invention is to develop a method for maintaining a local database of files in each of the devices.

Still another object of the present invention is to develop a method for synchronizing the local databases of the devices using transaction logs and a sync controller.

Still another object of the present invention is to develop a method for managing and accessing file(s) among the devices using the database.

Another main object of the present invention is to develop a system to seamlessly manage and access files across multiple devices, by establishing a network.

Yet another object of the present invention is to develop means for maintaining a local database of files in each of the devices.

Still another object of the present invention is to develop a sync controller to synchronize the local database of the devices.

Still another object of the present invention is to develop a means for synchronizing the local databases of the devices using transaction logs and a sync controller.

Still another object of the present invention is to develop a means to store shared files.

Another main object of the present invention is to develop apparatus to share file(s) among devices in a network.

Yet another object of the present invention is to develop a sync client within the apparatus for interaction with sync controller.

Still another object of the present invention is to develop a file transfer client and a file transfer server within the apparatus for transferring files between the devices.

Still another object of the present invention is to develop means to list and access from the apparatus all the files shared among the devices in the network.

Still another object of the present invention is to develop means for the user to render files shared among the devices in the network.

### STATEMENT OF INVENTION

The present invention is related to a method to seamlessly manage and access files across multiple devices in a network, comprising steps of maintaining a local database in each of the devices, synchronizing the local databases of the devices using transaction logs and a sync controller, and managing and accessing file(s) among the devices using the database; and a system to seamlessly manage and access files across multiple devices, by establishing a network comprising of means for maintaining a local database in each of the devices, sync controller to synchronize the local database of the devices, means for synchronizing the local databases of the devices using transaction logs and a sync controller and means to store shared files; and An apparatus to share file(s) among devices in a network comprising sync client for interaction with sync controller, file transfer client and server for transferring files between the devices, means to list and access the shared files and means to render the shared files.

### DETAILED DESCRIPTION OF THE INVENTION

Accordingly, the present invention relates to a method to seamlessly manage and access files across multiple devices in a network, comprising steps of:
a) maintaining a local database in each of the devices,
b) synchronizing the local databases of the devices using transaction logs and a sync controller, and
c) managing and accessing file(s) among the devices using the database.

In another embodiment of the present invention, the method further comprises of a sync controller that is fixed or selected dynamically by election.

In yet another embodiment of the present invention the sync controller maintains a list of devices allowed to share file(s).

In still another embodiment of the present invention sync controller provides device authentication.

In still another embodiment of the present invention sync controller interacts with sync client(s) of the device(s).

In still another embodiment of the present invention the devices download and store the files from other devices or access them without downloading.

In still another embodiment of the present invention the databases of all the devices are updated whenever any device switches into or out of network.

In still another embodiment of the present invention the databases of all the devices are updated to reflect change(s) made to the collection of shared files in any device.

In still another embodiment of the present invention, the change to the collection of shared files is addition, deletion or modification of file(s).

In still another embodiment of the present invention, the deletion is global or local deletion.

In still another embodiment of the present invention, the synchronization of the database is done using a sync controller.

In still another embodiment of the present invention, the database comprises of a list of shared file(s) with details of the file(s).

In still another embodiment of the present invention the details are selected from a group comprising filename, location, size, type, properties, author, album in the case of music files and combination(s) thereof.

In still another embodiment of the present invention the updating is done automatically using transaction logs.

In still another embodiment of the present invention user need not know the location of the file(s) being downloaded or accessed without downloading.

In still another embodiment of the present invention the file is selected from a group comprising audio, video, image and text.

In still another embodiment of the present invention the network is either internet or LAN.

In still another embodiment of the present invention the networking is wired or/and wireless.

Another main embodiment of the present invention is a system to seamlessly manage and access files across multiple devices, by establishing a network comprising of:
a. means for maintaining a local database in each of the devices
b. sync controller to synchronize the local database of the devices,
c. means for synchronizing the local databases of the devices using transaction logs and a sync controller, and
d. means to store shared files.

In yet another embodiment of the present invention files are stored in a file-storage-area.

In still another embodiment of the present invention at least one device should have file-storage-area.

In still another embodiment of the present invention file-storage-area comprises of means to store files in different electronic media internal or external to the device.

In still another embodiment of the present invention the file-storage-area external to the device is accessed through wired or wireless interface such as USB or Bluetooth.

Another main embodiment of the present invention is an apparatus to share file(s) among devices in a network comprising,
a. sync client for interaction with sync controller,
b. file transfer client and server for transferring files between the devices,
c. means to list and access files and
d. means to render files.

In yet another embodiment of the present invention the sync client uses Bluetooth or Ethernet or WiFi or WiMax.

In still another embodiment of the present invention the files accessed by the device can be stored in different electronic media internal or external to the device In still another embodiment of the present invention wherein the file access is through wired or wireless interface such as USB or Bluetooth

### DETAILED DESCRIPTION OF FIGURES

FIG. 1: represents three devices having different files in them.

FIG. 2: represents view of each device using AudiGo architecture

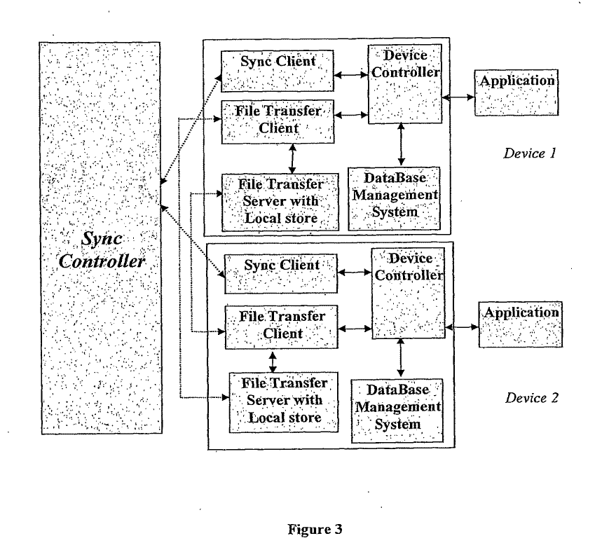

FIG. 3: represents AudiGo architecture

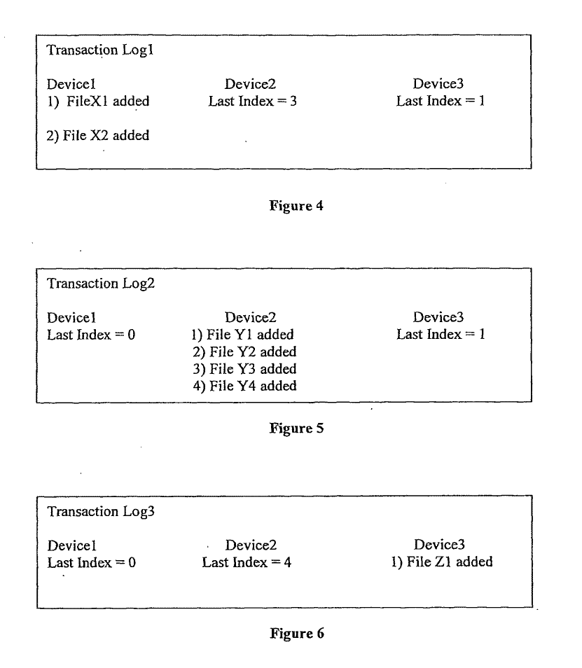

FIG. 4: represents Translation log of Device1. (TranslationLog1)

FIG. 5: represents Translation log of Device2. (TranslationLog2)

FIG. 6: represents Translation log of Device3. (TranslationLog3)

FIG. 7: shows AudiGo Architecture covering various different devices across its network.

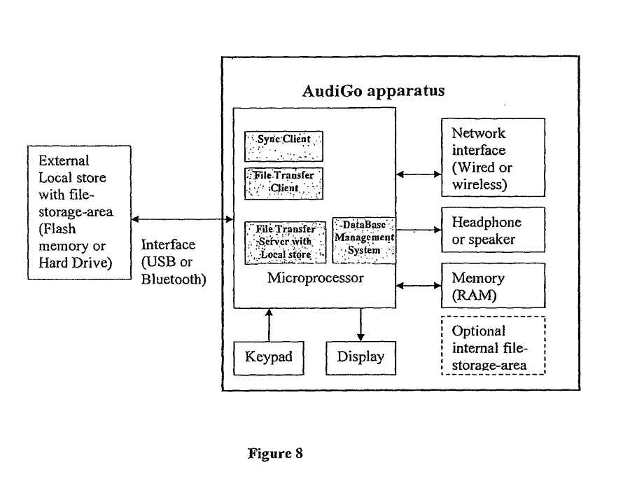

FIG. 8: represents connecting a storage device to AudiGo apparatus.

The various blocks of the AudiGo architecture are shown in FIG. 3 and explanation on functional aspects for various blocks is given below.

### AudiGo Device Controller (ADC)

This is the component that interfaces to the Application and controls or responds to all other AudiGo components in the device. It interacts with three components, Database Management System (DBMS), AudiGo Sync Client (ASC) and the application. ADC has two main functionalities.

Updating the Database: Whenever the user adds/deletes a file in his collection of shared files the application informs ADC about it. ADC first talks to DBMS to make the appropriate changes like add/delete to the database. Then it talks to the ASC to inform it that there is a change in the database.

Similarly, when files are added/deleted in other device, ADC gets that information from the ASC and interacts with the DBMS to add the file to the database. It also tells the application about the changes to the database, so that the user knows about it.

Accessing files: Also, when the application wants to access a file from the database, first the ADC interacts with the Database Management System to get info about the file. Then it calls Audio File Transfer Client to get the actual file.

AudiGo File Transfer Server (AFTS)

Each device that wants to connect to other devices has an area called LocalStore. LocalStore is an area in which all the files that the device wants to share with other devices are stored. A device can make its entire file storage area as the LocalStore or can make only a part of it as LocalStore. Some devices may not have a LocalStore (devices without file storage area). LocalStore will usually be a directory, under which the files that have to be shared are stored.

AFTS is the only module, which has access to the Local Store and provides interfaces for doing the following operations:
Reading/writing files from/to the Local Store.
When other devices want to read the files from the Local store, their requests are also handled by the AFTS.
Files that are read from the other devices are also stored in the LocalStore.
In short it is AFTS' responsibility to maintain the Local store.

### AudiGo Database Management System (ADMS)

The key component of the AudiGo Architecture is the Database. This Database contains information about all the files present in all the devices that are connected in AudiGo.

For each file, the database contains the following information:
File Name
List of devices in which the file is available along with the complete path in each of those devices.
File Size
File properties (Type of file, permissions etc)

The ADMS is responsible for maintaining the database. The ADM provides interfaces for adding/deleting or querying entries. The AudiGo Device Controller is the module that talcs to the ADMS and gets its services. The interfaces (APIs) for the AudiGo Device Controller to the ADMS will be as follows.
1. Create Database
2. Delete Database
3. Add Device to Database (Adds an entry for a new device in the DatabaseInfo)
4. Delete Device from Database (Adds an entry for a new device in the DatabaseInfo)
5. Add file to the Database
6. Delete file from the Database
7. Put Entry into the Database
A typical database entry will be in the format given below:

DeviceID:FileID; FileName; FileType; FileSize; Local path; No of Devices that has the file copy; List of Devices that has file; Artist Name; Album Name; Genre

Some of the entries are mandatory and some are optional. The database in a device, say Device1, will probably look like as given below: (Different fields are separated by semi-colons)

1: 1; minnale.mp3; MP3; 2054654 ; my_music/harris/minnale.mp3;3;1,2,3 ; Bombay
Jayashree ; Minnale ; Melody
1; 2;vaseegara.mp3 ; MP3 ; 40343234 ; my_music/harris/vaseegara.mp3;1 ; 1;
Bombay Jayashree ; Minnale; Melody
2 ;1 ; newyork.wma ; WMA ; 40454334; ;2;2,3 ; Hariharan ; Sillunu Oru kaadhal ;
Rock
2 ; 2 ; western.mp3 ; MP3 ; 1023434 ; my_music/classical/western.mp3 ;3 ; 1,2,3;

ADMS processes requests from Device Controller to add/delete files to the database. Whenever the application requests for any file from the Database, the Device Controller talcs to the ADMS, gets the information regarding the path and interacts with the AudiGo File Transfer Client (AFTC) module to get the file.

### AudiGo File Transfer Client (AFTC)

The primary job of the AFTC module is to read files. It interacts with AudiGo Device Controller (ADC) and AudiGo File Transfer Server (AFTS). Whenever ADC wants to read a file present in the database, it tells AFTC. If the file is present in the same device itself, AFTC interacts with the Local AFTS to get the file. If the file is not present in the same device but present in another device, it contacts the AFTS of the corresponding device to get the file. When a file from any other device is read, AFTC can also store it in the Local Store through the local AFTS.

### AudiGo Sync Controller (ASC)

AudiGo Sync Controller controls the automatic synchronization of the AudiGo devices. The AudiGo Sync Controller can be fixed or can be elected dynamically. Typically when all AudiGo devices are connected through internet, there will be a Fixed Sync Controller. Fixed Sync Controllers are expected to be always running.

When the devices are connected through a local LAN, Sync Controller can either be fixed or dynamically elected. A Dynamic Sync Controller mode is chosen, when none of the AudiGo devices are guaranteed to be always running.

The ASC has two important functionalities, namely User Registration and Database Synchronization.
1) User Registration:
a) In the Fixed Sync Controller scenario, there is a fixed Sync Controller that will never be switched off. Whenever a new device comes up, it first contacts the Sync Controller and logs in. The Sync Controller then authenticates the device as to whether it is a registered device. The Sync Controller keeps a complete list of authorized devices, which are allowed to sync with each other. This helps in avoiding unauthorized devices accessing the files. The Sync Controller also sends the list of devices logged in to all the other logged in devices.
b) In the Dynamic Sync Controller scenario, where one or more devices have the capability of becoming the Sync Controller, devices elect one among themselves as the Sync Controller (See scenario 1 and 10 for Sync Controller election details). Once the Sync Controller is elected, it acts like the Sync Controller as described in the Fixed Sync Controller case.
2) Database Synchronization: Whenever a new file is added or deleted in a device, the device that made the change informs the Sync Controller about it, through its Sync Client. Then the Sync Controller contacts the Sync Client of each of the active devices and informs them about the change. Thus the automatic synchronization of the database is taken care of by the Sync Controller. However, Sync Controller itself does not keep a copy of the database. It only facilitates and controls the synchronization of the database.

Sync Controller is not involved in accessing files. Accessing of files is handled directly by the AudiGo File Transfer Client and AudiGo File Transfer Server components.

### Sync Client

Sync Client is the component on each device that interacts with the Sync Controller. It is responsible for all the interactions with the Sync Controller. Whenever the device comes up, the sync client sends a message to the Sync Controller and starts the login procedure. Sync Client then checks if any changes had been made to the database while the device has not been connected. If so, it informs the Sync Controller that there had been changes in the database so that the other devices can know about the changes. Whenever there is a change in database (i.e. user adds or deletes a file to the Local Store), the Device Controller informs the Sync Client about it. If the device is connected to the AudiGo network, Sync Client sends a message to the Sync Controller that there is a change in database.

When Sync Controller sends a message that the database is changed by another device, Sync Client interacts with AudiGo Device Controller to process all the transactions sent by the Sync Controller.
There could be two types of devices.
a) Devices without file-storage-area

These types of devices will not have any significant amount of solid state memory such as Hard Disk or Flash. So, they cannot have the LocalStore and hence cannot run the File Transfer Server module.

They may or may not have sufficient amount of memory to maintain a local copy of the Database. If they do not maintain a local copy of the Database, they will get it from another device with file-storage-area.
b) Devices with file-storage-area

These devices can have a LocalStore. So, they have the capability of running the File Transfer Server. If an AudiGo network should be formed, at least one of the devices should be a “Device with file-storage-area”.

### Database Synchronization

Transaction Log: All transactions done by a device are maintained in a file called the Transaction Log. Eg. Device1 maintains Transaction log1, which contains a list of transactions initiated by it, Device2 maintains Transaction log2 which contains a list of transactions initiated by Device2 and so on . . . Each device maintains its own Transaction Logs. The other devices don't keep a copy of the transaction Logs of other devices. This file is required for synchronizing when devices move in and out of the network. The details are described below. The synchronization mechanism is explained with an example. Let's assume there are three registered devices in the network. Device1, Device2 and Device3, having Transaction logs 1, 2 and 3 respectively as shown below. Let's say all devices are down at the moment. Assumption is that there are totally 3 registered devices. Various possible scenarios pertaining to Database synchronization are as given below.

### Scenario 1: First Device Comes Up

When the first device (Device1) comes up, then
a) In the “Dynamic Sync Controller” scenario, it will broadcast, informing that it is up and querying for the Sync Controller. If there is no response to this, the device (Device1) will become the Sync Controller. If the Device changes network in between, it should restart the broadcast. If two devices come up together there will be a Sync Controller election, which is described in Scenario 10 below.
b) In the “Fixed Sync Controller” scenario, Device1 will try to connect to the Fixed Sync Controller. If the Sync Controller is down for some reason, the situation is similar to the case when it is not connected to the network.

The descriptions below provide the relevant information to explain how the databases of all the devices are kept updated.

### The Interpretation of the Transaction Logs is as Follows.

If any file is added to the Database, this transaction is logged in the Transaction Log of this device (Device1). Let's say FileX1 and File X2 were added to the Database, the transaction log for device1 will record this transaction. The Transaction log also has last transaction index of all other devices updated by this device (Device1). The transaction log file of Device1 will be as shown in FIG. 4. The Device1 after logging in has added files X1 and X2, which are not updated to devices Device2 and Device3, because Device2 and Device3 are not currently logged in. Also, the last index of Device2 in Device1 is 3, which means that the latest update done by Device2 (addition of File Y4) has not been updated in Device1's Database. However it is synchronized to Device3's Database (Last Index=4 for Device2 in Device3's transaction Log shown in FIG. 6). This could be because Device1 logged off before Device2 did this particular Database update. However, both Device1 and Device2 are synchronized to Device3's transactions. And Device1 has not initiated any transaction in the past. Its only now when it logged in that it added two files X1 and X2. Also at some point in the past all three of them logged off. And then Device1 came up first. It found that there is no other device connected in the network and took up the role of the Sync Controller.

Note that the user does not know anything about the transaction logs. It is an internal construct of the AudiGo Syncing mechanism. All the user has to do is to add a file to the LocalStore, and it is the responsibility of the AudiGo to add it to the database and to the transaction logs and make sure that the other devices automatically update their database.

How will the transaction file size be cleared so as to prevent the transaction file size to become huge in the due course?

When the Device makes sure that the transaction initiated by it has been synced with all devices, then it deletes that entry from its transaction. Whenever a device has finished syncing the particular transaction initiated by it, the Sync Controller informs the Device about the same. When all the Devices have synced the transaction, it will be deleted from the Transaction log of the Device which initiated it. The transaction logs are used by the AudioGo Sync Client and AudiGo Sync Controller in synchronizing the database across all devices.

### Scenario 2: Second Device Comes Up (Basic Synchronization Mechanism)

Now let's say Device2 comes into the network, then
a) In the “Dynamic Sync Controller” scenario, Device2 broadcasts that it has come into the network, and waits for response from the Sync Controller. Since Device1 is already in the network and acts as the Sync Controller, it replies to this broadcast saying that it is the Sync Controller.
b) In the “Fixed Sync Controller” scenario, the device informs the Sync Controller that it has come into the network.

The Sync Controller adds Device2 to the USER_LIST and updates Device2 and Device1 with the new USER_LIST. Then Sync Controller queries Device2 for its Transaction Index. As seen from the FIG. 5, Device2 returns the Index 4. Now the Sync Controller checks and finds that Device1's Last Index for Device2 is 3, which is less than 4, which means that Device2 has some transaction not yet updated by Device1. The Sync Controller gets this transaction and updates Device1 of the same. The Sync Controller has now synchronized Device2's transaction in Device1. The Sync Controller asks for the Last Index of Device1 on Device2. Device2 will return 0 (as seen from the Transaction file). Now the Sync Controller finds, after checking Device1's Transaction Log that Device1's Transaction index(2) is greater than 0. The Sync Controller then synchronizes Device2 with transactions 1 and 2 of Device1. Now the devices Device1 and Device2 are completely in sync and the login process of Device2 is complete.

Also, Device2 updates the information that Device1 has synced, and since Device3 has already synced earlier (which it would have already recorded), it will remove this transaction from its Transaction File.

### Scenario3: Third Device Comes Up

Now if Device3 comes into the network, then
a) In the “Dynamic Sync Controller” scenario, it broadcasts querying for the Sync Controller. The Sync Controller in Device1 responds to this and adds Device3 also to the USER_LIST.
b) In the Fixed Sync Controller scenario, it informs the fixed Sync Controller about its entering the network.

The login process of Device3 starts. The Sync Controller queries for Device3's Transaction Index and checks if Device1's and Device2's Last Index of Device3 is less than the current Transaction Index of Device3. In this case it finds that it is not so. The Sync Controller then asks for Device3's Last Index of Device1, finds that it is 0, which is less than Device1's Transaction Index and hence updates Device3 with Device1's transactions. Then it queries for Device3's Last Index of Device2. The Sync Controller also gets the current Transaction Index of Device2 from Device2. It checks and finds out that both are same and hence concludes that Device2 and Device3 are already in sync. If it is different it synchronizes them. After this, the login of Device3 is complete. Sync Controller updates the USER_LIST with Device3 and informs Device1 and Device2 of the same, and gives the entire USER_LIST to the Device3. Now all the 3 users are in the network and their Databases are fully synchronized.

### Scenario4: Addition of New File

Let's say the current condition is that all devices are in the network. If any of the devices, say Device2 wants to add a file to the Database, it sends a request to the Sync Controller. The Sync Controller gives a positive acknowledgement to Device2 and sends an UPDATE_REQUEST to Device1 and Device3 sequentially. Once a file is shared by the user, Transaction Log will be updated.

### Scenario5: Reading a File

When a device, say Device1, wants to read a file from the Database, it searches the database to locate the devices where the file is present. If the file is present in Device1's LocalStore, it is read from the LocalStore itself. If the file is not present in Device1 and is present in say Device2, the AudiGo File Transfer Client of Device1 talks to the AudiGo File Transfer Server of Device2. The file then which is currently being read is locked, so that any attempts to modify/delete it will not be successful.

### Scenario6: Deletion of a File

There are two types of deletion.
i) Local delete: Here the file is deleted only from the LocalStore of the respective device only, but not from other devices which has a copy of it stored in their LocalStore. This happens when a file is stored in multiple devices and the user wants to remove it from a particular device, but not from the Database.
ii) Global Delete: Here the file is removed from all devices where a copy of it is stored. Also the corresponding entry for the file in the database is also removed. This happens, when the user wants to remove a file from his entire collection of shared files.

When a device wants to do a delete (Local or Global), the application makes a request to the AudiGo Device Controller. ADC interacts with the ADMS to process the transaction. It then informs AudiGo Sync Client about this new transaction. The Sync Client sends a message to the AudiGo Sync Controller about this new transaction. The Sync Controller in turn sends a message to AudiGo Sync Client of all the active devices about this transaction, so that they can update their database accordingly.

### Scenario 7: Deletion and Reading Simultaneously of the Same File

If a File is being read from Device1 by Device2 and let's say Device3 wants to delete the file, then Device3 will request the Sync Controller for the same. The Sync Controller will send separate requests to all devices. When the Sync Controller sends this request to Device1, Device1 will find that the file is locked for reading and will not delete the file as well as the entry from the Database immediately. It will buffer this request up and will do the deletion once the reading of the file is complete. In case the Device3 goes out of the network or is switched off before it is actually able to do the deletion, the deletion will happen when the device logs into the network next time.

### Scenario8: Trying to Read a File for Which Delete has Already Been Issued

File1 is being deleted from the Database by the Sync Controller. It does this by sending separate request to Devices. Let's say that Device1 and Device2 have a copy of the file and Device3 does not have a copy of the file and wants to access it from Device1 or Device2. The Sync Controller sends the Delete transaction to Device1, Device2 and Device3 in that order. There are two scenarios associated with this.
a) Let's say the Sync Controller has completed deleting from Device1 and is deleting from Device2. Then if Device3 requests a read from the Device1 it will encounter a read failure.
b) Let's say the Sync Controller is deleting from Device1, and Device3 simultaneously tries to read the file from Device2. Sync Controller will delete it from Device1. Then it will wait for Device3 to copy the file from Device2 and then delete it from Device2. It will delete it from Device3 also once Device3 is done with using the file.

### Scenario9: Device Which is the Current Dynamic Sync Controller Terminates Abnormally

When a Device which is in the network needs the service of the Sync Controller, and when it does not get any response, it assumes the role of the Sync Controller.

Scenario10: In a “Dynamic Sync Controller” Network, When There is No Currently Active AudiGo Sync Controller, What Happens When Two Devices Come into the Network Simultaneously? How Will a Decision be Made of Who Will be the Sync Controller.

Let's say DeviceA entered a network where there is no Sync Controller currently. DeviceA broadcasts a message that it has arrived in the network, 3 times; there is no sync controller currently active in the network, so nobody responds. DeviceA then sends out a broadcast informing its wish to become a Sync Controller. It sends out this broadcast 4 times. If no other device reports a conflict, which is what will happen in this case, DeviceA will become the Sync Controller.

Now if two Devices, DeviceA and DeviceB enter the network at the same time, each device starts broadcasting its presence and expects a feedback from any existing Sync Controller. After 3 retransmissions when the devices time out, each Device sends out a broadcast informing its wish to become the Sync Controller. Now based on a Sync Controller election mechanism (some kind of priority) one of the devices will report a conflict to the wish of the other Device to become the Sync Controller. For example, lets say the Sync Controller election criterion is that when two devices try to become Sync Controller at the same time, the Device with the MAC address lesser than the other gets the priority. Then let's say DeviceA has a lesser MAC address then Device A will report a conflict to DeviceB's wish to become a Sync Controller.
Conflicts could be expressed by devices in the following scenarios:
a) A Sync Controller already exists in the network, will express a conflict if someone else sends this message to expressing its wish to become the Sync Controller.
b) Any device which has just entered the network and is trying to find the Sync Controller, could also report a conflict if it receives a message from another device expressing its wish to become the Sync Controller, in which case, going ahead the Device which reported the conflict might become the Sync Controller.
   Scenario11: If There are Three Devices DeviceA, DeviceB and DeviceC. Initially Lets Say DeviceA and DeviceB was in the Network DeviceA Added Some Files to the Network, DeviceB Synced Up with it, Made Copies of Some of the Files. Now Lets Say DeviceA Goes Out of Network and Later DeviceC Comes into the Network, What Should DeviceC Do? Somehow it Should Sync All the Changes Done by DeviceA Before it Went Out. How Will it do This?

Let's say DeviceA added files File1, File2, File3 to the Database. This information was synchronized with DeviceB but not with DeviceC because DeviceC was not in the network. And Lets say DeviceB had a copy of File2. The transaction logs of a device will have the information about the transactions of that device. So if a copy of the file was made by DeviceB, then the copy transaction will be present in its transaction log of DeviceB. So now, when DeviceC comes up, and finds that only DeviceB is present in the network, in the synchronizing process, DeviceC updates its Database about File2, but not about File1 and File3. So the user of DeviceC will not be able to find File1 and File3 in its Database list. The info about File1 and File3 will be updated when DeviceA comes into the network. DeviceC will synchronize with DeviceA when this happens.

Scenario 12: If One of the Devices Which is Not a Sync Controller Goes Down, How Will that be Detected?
This can happen in two ways:
a) When the Sync Controller sends some request to the Device which is out of the network without properly logging off, the Device will not respond and then the Sync Controller will identify that the Device is down.
b) When one Device, lets say DeviceA tries to read a file from DeviceB, and DeviceB does not respond, DeviceA understands that DeviceB might be down and so informs the Sync Controller about the same. Now the Sync Controller pings the DeviceB and makes sure that DeviceB is down and marks DeviceB as logged off.
   Scenario 13: First Device Which Added the File into the Network Goes Down, When a Copy is Being Made.

The Devices with lot of memory would want to maintain a copy of all the files in the Database. Lets say DeviceA adds a file to the Database, and when the Sync Controller updates the DeviceB about the same, the DeviceB might decide to make a copy of the file always. Now to make a copy, the DeviceB should send a separate request to the Sync Controller. But DeviceA which added the file could go down by that time, in which case a copy can be made by DeviceB only when DeviceA logs in next time.

### Scenario14: What Happens if the Sync Controller Goes Down in Between a Delete or Syncing Operation?

Every Device, say DeviceA when it requests something from the Sync Controller, expects an ACK once the request is completely processed by the Sync Controller. Also, DeviceA pings the Sync Controller periodically to know the status of the request. The Device does the ping to ensure that the Sync Controller does not go down in between. If DeviceA finds that the Sync Controller has gone down before it has received the ACK, then DeviceA will initiate a Sync Controller election as described above (by sending a broadcast expressing its interest to become the Sync Controller) and become the Sync Controller. If any other device, say DeviceB tries to become a Sync Controller before DeviceA found that the Sync Controller is down, then DeviceA which has a transaction pending (i.e. Before it getting the ACK the Sync Controller went down) will have the priority to become the Sync Controller and it will report a conflict to the wish of DeviceB attempting to become the Sync Controller.

### Network Related Assumptions

It should be possible for the Device to know whether it is connected to the network or not at any point of time by calling some low level APIs.
It should be possible for the Device to know when it changes from one network to another.

### LocalStore Abstraction

The LocalStore need not necessarily be a folder in the particular device's hard disk; it could be another USB device, or a Bluetooth device etc. . . . Reading and Writing to the LocalStore will be properly abstracted so that AudiGo software will work across different type of storages. Two clients could run on a PC, one having the hard disk as the Local Store and the other having a USB device as the local store.

### Network Abstraction

The AudiGo application should be well abstracted from the underlying network (APIs should be defined to take care of this). i.e. the AudiGo application itself should not make any assumptions about the underlying network, (eg. It should not assume that it is Ethernet or Wireless network etc . . . )

### Limitations in the Absence of Network

a) If a device is not connected to the network, the device may not be able to access all files in the Database. The device may not be able to access files in the Database for which it has not maintained a copy.
b) Deletion of files from the Database or Global Delete may not work if the Device is not connected to the network.

### Apparatus Description

The apparatus enables the sharing of files across a multiplicity of such apparatus or systems with the AudiGo software. An instantiation of such an apparatus is shown in FIG. 8. The apparatus can have internal storage area such as Flash, hard disk, SD card etc, or connect to an external storage device through a variety of possible interfaces. Examples of the external storage interfaces are USB or Bluetooth. If the storage is external, the external storage device becomes the LocalStore for the AudiGo apparatus. The rest of the AudiGo functionality is resident in the apparatus. The apparatus interfaces to the other such apparatus in the AudiGo network using wired or wireless IP networking. The AudiGo apparatus thus shares the files present within itself or the external storage device with the other devices in the AudiGo network. AudiGo is subject matter of trademark.

1-30. (canceled)

31. A method to seamlessly manage and access files across multiple devices in a network, comprising steps of:
a) maintaining a local database comprising details of the file(s) shared in each of the devices.
b) synchronizing the local databases of the devices using transaction logs and a sync controller, and
c) managing and accessing file(s) among the devices using the database.

32. The method as claimed in claim 31, wherein the sync controller is fixed or selected dynamically by election.

33. The method as claimed in claim 31, wherein the sync controller maintains a list of devices allowed to share file(s).

34. The method as claimed in claim 31, wherein sync controller provides device authentication apart from interaction with sync client of the device(s).

35. The method as claimed in claim 31, wherein the devices download and store the files from other devices or access them without downloading.

36. The method as claimed in claim 35, wherein user need not know the location of the file(s) being downloaded or accessed without downloading.

37. The method as claimed in claim 31, wherein the databases of all the devices are updated whenever any device switches into or out of the network.

38. The method as claimed in claim 31, wherein the databases of all the devices are updated to reflect change(s) made to the collection of shared files in any device and said change is addition, deletion or modification of file(s).

39. The method as claimed in claim 38, wherein the deletion is global or local deletes.

40. The method as claimed in claim 37, wherein the updating is done automatically using transaction logs.

41. The method as claimed in claim 31, wherein the details are selected from a group comprising filename, location, size, type, properties, author, album in the case of music files and combination(s) thereof.

42. The method as claimed in claim 31, wherein the file is selected from a group comprising audio, video, image and text.

43. A system to seamlessly manage and access files across multiple devices, by establishing a network comprising of:
a) means for maintaining a local database comprising details of the file(s) shared in each of the devices.
b) sync controller to synchronize the local database of the devices,
c) means for synchronizing the local databases of the devices using transaction logs and a sync controller, and
d) means to store shared files.

44. The system as claimed in claim 43, wherein files are stored in file-storage-area.

45. The system as claimed in claim 44, wherein the file-storage-area comprises of means to store files in different electronic media internal or external to the device

46. The system as claimed in claim 44, wherein the file-storage-area external to the device is accessed through wired or wireless interface such as USB or Bluetooth

47. The system as claimed in claim 43, wherein at least one device should have file-storage-area.

48. The system as claimed in claim 43, wherein the network uses wired or/and wireless communication.

49. An apparatus to share file(s) among devices in a network comprising,
a) sync client for interaction with sync controller,
b) file transfer client and server for transferring files between the devices,
c) means to list and access files and
d) means for the user to render files

50. The method as claimed in claim 38, wherein the updating is done automatically using transaction logs.
